(19) United States
(12) Patent Application Publication
(10) Pub. No.: US 2024/0034666 A1
(43) Pub. Date: Feb. 1, 2024

(54) FINING PACKAGES FOR GLASS COMPOSITIONS

(71) Applicant: CORNING INCORPORATED, Corning, NY (US)

(72) Inventors: Tiphaine Fevre, Paris (FR); Scott Michael Jarvis, Ithaca, NY (US); Adam Robert Sarafian, Corning, NY (US); Emily Kathryn Sarafian, Corning, NY (US); Joseph Martin Wright, Corning, NY (US)

(21) Appl. No.: 18/227,470

(22) Filed: Jul. 28, 2023

Related U.S. Application Data
(60) Provisional application No. 63/393,067, filed on Jul. 28, 2022.

(51) Int. Cl. C03C 1/00; C03C 3/093; C03C 3/118; C03C 3/095; A61J 1/06; A61J 1/14

(52) U.S. Cl. CPC C03C 1/004; C03C 3/093; C03C 3/118; C03C 3/095; A61J 1/065; A61J 1/1468

(57) ABSTRACT

A fining package for a glass composition may include a sulfate or a sulfide in an amount from about 0.001 to about 1 mol % of the glass composition. The fining package may include a multivalent compound, such as CeO₂, SnO₂, or Fe₂O₃, in an amount from about 0.001 to about 1 mol % of the glass composition. The fining package may be sulfide-free. The fining package may be free from a reducing agent for reducing sulfate to sulfide. The fining package may be free of at least one of Cl, F, Sn, Ce, and As. The glass composition may be used to form glass tubing. The glass tubing may be used to form a pharmaceutical packaging.

### CROSS-REFERENCE TO RELATED APPLICATIONS

This application claims the benefit of priority under 35 U.S.C. § 119 of U.S. Provisional Application Ser. No. 63/393,067 filed on Jul. 28, 2022, the content of which is relied upon and incorporated herein by reference in its entirety.

### FIELD OF THE DISCLOSURE

This disclosure generally relates to glass fining and particularly relates to fining packages for glass compositions to be used for glass tubing and pharmaceutical packaging.

### BACKGROUND

Due to safety considerations, regulatory bodies analyze packaging materials in which pharmaceuticals are stored or administered from. For instance, regulatory bodies limit the type and amount of materials present in pharmaceutical packaging, such as closed ampoules. Such pharmaceutical packaging is made of glass, which due to the type of material and the industrial manufacturing processes used, is typically not washed before the ampoules are filled with the respective pharmaceutical composition. Some processes by which glass is manufactured at an industrial scale involve materials that are considered toxic or that can be present in amounts that may not be considered safe. For example, fining is a process by which glass is formed that may involve regulated materials. Fining agents are introduced to the glass composition to clear the gas or bubbles from the composition, thereby reducing bubbles in the formed glass and increasing clarity of the glass.

For example, a typical fining agent for borosilicate glasses is sodium chloride (NaCl), which is particularly efficient for the borosilicate glasses. During such conventional fining, the NaCl recondenses on the internal walls of glass tubing during converting. Closed ampoules are opened just before filling, such as through a flame or cut, and thus are typically unable to be washed preliminarily. Because closed ampoules are not typically washed before filling, and because the NaCl remains on the internal walls of the ampoules, the NaCl may mix with the fill fluid when the ampoules are filled. However, for such glass tubing to be used as closed ampoules for pharmaceutical packaging, the glass composition needs to contain a level of chloride (Cl) that is low enough to meet European Pharmacopoeia (EP) requirements. Per edition 10.4 of the European Pharmacopoeia, the test for chlorides for sterilized water for injections is a maximum 0.5 ppm for containers with a nominal volume of 100 mL or less.

In some instances, borosilicate glasses with a low Cl content may be used to attempt to achieve a level of chloride low enough to meet the EP requirements. To address fining of glasses with a low chloride content, fining agents such as As₂O₃, Sb₂O₃, F, CeO₂, or SnO₂ are typically used. However, certain fining agents have high toxicity, such as As. Even if the levels of such toxic agents in the final glass are kept acceptably low, their toxicity can be dangerous for people working in the manufacturing of the glass. When fining glass for pharmaceutical applications, fining agents As₂O₃ and Sb₂O₃ may be avoided due to toxicity, which leads to fining packages that are complex, include multiple fining agents, and are expensive due to the increased amounts and types of raw materials. Despite the complexity, such fining packages typically have a lower fining quality than using NaCl as a fining agent. Agents such as Cl and/or F are less dangerous than some more toxic agents, but are corrosive to the pollution abatement systems or otherwise undesired to users for certain applications. Sn, for example, when used as a fining agent may present evaporation/condensation issues that can result in cosmetic defects. In addition, Sn is a new element to the pharmaceutical industry, which can cause hesitancy of adoption, and it is an expensive material.

Lower-cost alternatives to typical fining agents are desired. Similarly, fining agents that can achieve effective fining results at lower quantities of the fining agents can reduce batch costs because less of the fining agent is required per batch. In addition, some glass compositions require high fining temperatures in order to reach the appropriate fining viscosity, so fining packages suitable for such temperatures are also needed.

Therefore, a need exists for a simple, low-cost fining package for use in glass pharmaceutical packaging that maintains the fining performance as well as the glass and product properties, and that can be used at high fining temperatures of some glass compositions.

### SUMMARY

According to Aspect 1 of this disclosure, a fining package for a glass composition is provided comprising: a sulfate or a sulfide in an amount from about 0.001 to about 0.1 mol % of the glass composition.

According to Aspect 2, the fining package according to Aspect 1 is provided, wherein the fining package comprises the sulfate and is sulfide-free.

According to Aspect 3, the fining package according to Aspect 1 or Aspect 2 is provided, wherein the sulfate comprises at least one of an alkali sulfate and an alkaline earth sulfate.

According to Aspect 4, the fining package according to any of the preceding Aspects is provided, wherein the fining package further comprises a multivalent compound in an amount from about 0.001 to about 1 mol % of the glass composition.

According to Aspect 5, the fining package according to Aspect 4 is provided, wherein the multivalent compound comprises Sn or Ce.

According to Aspect 6, the fining package according to Aspect 5 is provided, wherein the multivalent compound comprises CeO₂, SnO₂, or Fe₂O₃.

According to Aspect 7, the fining package according to any of the preceding Aspects is provided, further comprising a nitrate in the amount of about 0.01% to about 0.1 mol % of the glass composition.

According to Aspect 8, the fining package according to any of the preceding Aspects is provided, wherein the sulfate comprises a heavy alkaline earth sulfate.

According to Aspect 9, the fining package according to Aspect 8 is provided, further comprising a redox modifier.

According to Aspect 10, the fining package according to Aspect 9 is provided, wherein the redox modifier is carbon, sugar, or nitrate.

According to Aspect 11, the fining package according to any of the preceding Aspects is provided, wherein the fining package is free of a reducing agent for reducing sulfate to sulfide.

According to Aspect 12, the fining package according to any of the preceding Aspects is provided, wherein the glass composition comprises a borosilicate glass composition.

According to Aspect 13, the fining package according to any of the preceding Aspects is provided, wherein the glass composition comprises an aluminosilicate glass composition.

According to Aspect 14, the fining package according to any of the preceding Aspects is provided, wherein the glass composition is used to form glass tubing.

According to Aspect 15, the fining package according to Aspect 14 is provided, wherein the glass tubing is used to form a pharmaceutical packaging.

According to Aspect 16, the fining package according to Aspect 15 is provided, wherein the pharmaceutical packaging comprises at least one of a vial, an ampoule, a syringe, and a cartridge.

According to Aspect 17, the fining package according to any of the preceding Aspects is provided, wherein the fining package is free of at least one of Cl, F, Sn, Ce, and As.

According to Aspect 18, the fining package according to any of the preceding Aspects is provided, wherein the glass composition comprises: SiO₂ in an amount of 70 to 76 wt % of the glass composition; B₂O₃ in an amount of 9 to 13.5 wt % of the glass composition; Al₂O₃ in an amount of 4 to 8 wt % of the glass composition; TiO₂ in an amount of 0 to 0.1 wt % of the glass composition; Fe₂O₃ in an amount of 0 to 0.1 wt % of the glass composition; BaO in an amount of 0 to 0.1 wt % of the glass composition; CaO in an amount of 0 to 3 wt % of the glass composition; Na₂O in an amount of 5 to 8.5 wt % of the glass composition; K₂O in an amount of 0.5 to 3 wt % of the glass composition; MgO in an amount of 0 to 1 wt % of the glass composition; Cl in an amount of 0 to 0.03 wt % of the glass composition; F in an amount of 0 to 0.02 wt % of the glass composition; CeO₂ in an amount of 0.08 to 0.5 wt % of the glass composition; SnO₂ in an amount of 0.02 to 0.23 wt % of the glass composition; and ZrO₂ in an amount of 0 to 0.08 wt % of the glass composition.

According to Aspect 19, the fining package according to Aspect 18 is provided, wherein the glass composition comprises: SiO₂ in an amount of 70 to 74 wt % of the glass composition; B₂O₃ in an amount of 10 to 13.5 wt % of the glass composition; Al₂O₃ in an amount of 5 to 7 wt % of the glass composition; TiO₂ in an amount of 0 to 0.03 wt % of the glass composition; Fe₂O₃ in an amount of 0 to 0.04 wt % of the glass composition; BaO in an amount of 0 to 0.04 wt % of the glass composition; CaO in an amount of 0.5 to 2.3 wt % of the glass composition; Na₂O in an amount of 6.5 to 7.5 wt % of the glass composition; K₂O in an amount of 1.0 to 1.8 wt % of the glass composition; MgO in an amount of 0 to 0.1 wt % of the glass composition; Cl in an amount of 0.01 to 0.03 wt % of the glass composition; F in an amount of 0 to 0.02 wt % of the glass composition; CeO₂ in an amount of 0.08 to 0.2 wt % of the glass composition; SnO₂ in an amount of 0.02 to 0.12 wt % of the glass composition; and ZrO₂ in an amount of 0 to 0.08 wt % of the glass composition.

According to Aspect 20, the fining package according to Aspect 19 is provided, wherein the glass composition comprises: SiO₂ in an amount of 70 to 73 wt % of the glass composition; B₂O₃ in an amount of 10.5 to 13.2 wt % of the glass composition; Al₂O₃ in an amount of 5 to 7 wt % of the glass composition; TiO₂ in an amount of 0 to 0.03 wt % of the glass composition; Fe₂O₃ in an amount of 0 to 0.04 wt % of the glass composition; BaO in an amount of 0 to 0.04 wt % of the glass composition; CaO in an amount of 1 to 2.3 wt % of the glass composition; Na₂O in an amount of 6.5 to 7.3 wt % of the glass composition; K₂O in an amount of 1.0 to 1.5 wt % of the glass composition; MgO in an amount of 0 to 0.1 wt % of the glass composition; Cl in an amount of 0.01 to 0.02 wt % of the glass composition; F in an amount of 0 to 0.02 wt % of the glass composition; CeO₂ in an amount of 0.08 to 0.2 wt % of the glass composition; SnO₂ in an amount of 0.02 to 0.12 wt % of the glass composition; and ZrO₂ in an amount of 0 to 0.08 wt % of the glass composition.

According to Aspect 21, the fining package according to any one of Aspects 1-17 is provided, wherein the glass composition comprises: SiO₂ in an amount of 75 to 85 wt % of the glass composition; B₂O₃ in an amount of 9.5 to 14.5 wt % of the glass composition; Al₂O₃ in an amount of 0.5 to 5 wt % of the glass composition; TiO₂ in an amount of 0 to 0.1 wt % of the glass composition; Fe₂O₃ in an amount of 0 to 0.1 wt % of the glass composition; BaO in an amount of to 0.1 wt % of the glass composition; Na₂O in an amount of 2 to 8 wt % of the glass composition; K₂O in an amount of 0 to 3 wt % of the glass composition; CaO and MgO in a total amount of 0 to 1.0 wt % of the glass composition; Cl in an amount of 0 to 0.10 wt % of the glass composition; and SnO₂ in an amount of 0 to 0.2 wt % of the glass composition

According to Aspect 22, the fining package according to any one of Aspects 1-17 is provided, wherein the glass composition comprises: SiO₂ in an amount of 74 to 80 wt % of the glass composition; Al₂O₃ in an amount of 4 to 8 wt % of the glass composition; CaO in an amount of 0 to 0.5 wt % of the glass composition; Na₂O in an amount of 8 to 14 wt % of the glass composition; MgO in an amount of 3 to 7 wt % of the glass composition; and SnO₂ in an amount of 0 to 0.23 wt % of the glass composition.

According to Aspect 23, a method of fining glass for forming pharmaceutical packaging is provided, the method comprising: fining a glass composition by adding the fining package of any one of claims 1-22 to the glass composition to remove gas bubbles; and forming glass tubing from the fined glass composition.

According to Aspect 24, the method according to Aspect 23 is provided, further comprising forming a pharmaceutical packaging from the glass tubing.

According to Aspect 25, the method according to Aspect 24 is provided, wherein the pharmaceutical packaging comprises a pharmaceutical ampoule.

According to Aspect 26, the method according to any of Aspects 23-25 is provided, wherein the fining is performed at a fining temperature of at least 1400° C.

According to Aspect 27, the method according to Aspect 26 is provided, wherein the fining temperature is at least 1500° C.

According to Aspect 28, the method according to Aspect 27 is provided, wherein the fining temperature is from about 1500° C. to about 1750° C., from about 1500° C. to about 1600° C., from about 1600° C. to about 1700° C., or from about 1550° C. to about 1650° C.

According to Aspect 29, the method according to Aspect 24 is provided, further comprising: melting a batch of materials for the glass composition, the batch of materials comprising sand with a D50 average particle size of greater than 200 microns, or greater than 300 microns.

Additional aspects of the present disclosure will be set forth, in part, in the detailed description, figures and any claims which follow, and in part will be derived from the detailed description, or can be learned by practice of the disclosure. It is to be understood that both the foregoing general description and the following detailed description are exemplary and explanatory only and are not restrictive of the disclosure as disclosed.

### BRIEF DESCRIPTION OF THE DRAWINGS

FIG. 1 is a comparison chart of photos of glass samples D1, D2, D3, and D4 formed as described in the present disclosure.

FIG. 2 is a bar graph showing the defects per cm³ counted in the samples D1, D2, D3, and D4 of FIG. 1, as described in the present disclosure.

FIG. 3 is a comparison chart of photos of glass samples D5, D6, D7, and D8 formed as described in the present disclosure.

FIG. 4 is a bar graph showing the defects per cm³ counted in the samples D5, D6, D7, and D8 of FIG. 3, as described in the present disclosure.

FIG. 5 is a comparison chart of photos of glass samples D9, D10, D11, and D12 formed as described in the present disclosure.

FIG. 6 is a bar graph showing the defects per cm³ counted in the samples D9, D10, D11, and D12 of FIG. 5, as described in the present disclosure.

FIG. 7 is a comparison chart of photos of glass samples D13, D14, D15, and D16 formed as described in the present disclosure.

FIG. 8 is a bar graph showing the defects per cm³ counted in the samples D13, D14, D15, and D16 of FIG. 7, as described in the present disclosure.

FIG. 9 is a comparison chart of photos of glass samples D17, D18, D19, and D20 formed as described in the present disclosure.

FIG. 10 is a bar graph showing the defects per cm³ counted in the samples D17, D18, D19, and D20 of FIG. 9, as described in the present disclosure.

FIG. 11 is a comparison chart of photos of glass samples D21, D22, D23, D24, and D25 formed as described in the present disclosure.

FIG. 12 is a bar graph showing the defects per cm³ counted in the samples D21, D22, D23, D24, and D25 of FIG. 11, as described in the present disclosure.

FIG. 13 is a comparison chart of photos of glass samples D26, D27, D28, D29, and D30 formed as described in the present disclosure.

FIG. 14 is a comparison chart of photos of glass samples D31 and D32 formed as described in the present disclosure.

FIG. 15 is a comparison chart of photos of glass samples D33 and D34 formed as described in the present disclosure.

FIG. 16 is a comparison chart of photos of glass samples D35a, D35b, D36a, and D36b formed as described in the present disclosure.

FIG. 17 is a bar graph showing the seeds per cm³ counted in the samples D35a, D35b, D36a, and D36b of FIG. 16, as well as the average number for samples D35 and D36, as described in the present disclosure.

FIG. 18 is a bar graph showing the solids per μm³ counted in the samples D35a, D35b, D36a, and D36b of FIG. 16, as well as the average number for samples D35 and D36, as described in the present disclosure.

FIG. 19 is a bar graph showing the seeds per cm³ counted in the samples D37a, D37b, D38a, and D38b, as well as the average number for samples D37 and D38, as described in the present disclosure.

FIG. 20 is a bar graph showing the solids per cm³ counted in the samples D37a, D37b, D38a, and D38b, as well as the average number for samples D37 and D38, as described in the present disclosure.

FIG. 21 is a bar graph showing the seeds per cm³ counted in the samples D39a, D39b, D40a, and D40b, as well as the average number for samples D39 and D40, as described in the present disclosure.

FIG. 22 is a bar graph showing the solids per μm³ counted in the samples D39a, D39b, D40a, and D40b, as well as the average number for samples D39 and D40, as described in the present disclosure.

FIG. 23 is a comparison chart of photos of glass samples D41, D42, D43, and D44 formed as described in the present disclosure.

FIG. 24 is a bar graph showing the defects per cm³ counted in the samples D41, D42, D43, and D44 of FIG. 23, as described in the present disclosure.

### DETAILED DESCRIPTION

Various aspects of the disclosure will be described in detail with reference to drawings, if any. Reference to various aspects does not limit the scope of the invention, which is limited only by the scope of the claims attached hereto. Additionally, any examples set forth in this specification are not limiting and merely set forth some of the many possible aspects of the claimed invention.

Aspects described herein provide a simple, low-cost fining package that using the addition of sulfates or sulfides replacing or drastically lowering the amount of halides and/or other commonly used multi-valent elements, such as Sn and Ce, present in the fining package compared to conventional fining packages for glass tubing formulated for pharmaceutical packaging. Methods described herein relate to fining of borosilicate and aluminosilicate glasses for glass tubing applications for use as pharmaceutical primary packaging. Embodiments of this disclosure include fining packages using sulfates and/or sulfides as low-cost alternatives to Sn and Ce fining agents, and additionally using low quantities of sulfate and/or sulfides can be used in the fining packages to effectively fine glass. Sulfate retention in glass is very low, and thus the use of sulfate as a fining agent should be relatively transparent to the end user. The fining packages disclosed herein can be used with glass compositions that require high fining temperatures. As used herein, “fining temperature” refers to the temperature of the glass composition needed for the glass to achieve fining viscosity, or the viscosity at which the glass is fined.

A problem with glass compositions having relatively high fining temperatures is finding suitable fining agents to remove bubbles from the glass and that are acceptable to a wide range of end users and/or acceptable for a wide range of uses, while also being low cost and gentle to the melting resources. For example, some may use the toxic element arsenic (As) as a fining agent, which at low levels in the glass may be harmless from the perspective of many end users, but is nonetheless potentially dangerous for people working in plants where arsenic is used. Other agents, like Cl and/or F, are less dangerous, but are corrosive to pollution abatement systems and some end users or applications, like closed ampoules, cannot tolerate Cl in the glass containers. Additionally, Sn is also commonly used as a fining agent, but has evaporation and/or condensation issues that result in some cosmetic defects. Sn is also a relatively new element to the pharmaceutical industry which can cause hesitancy of adoption, and it is an expensive raw material, as well.

One typical fining agent for such borosilicate glasses is sodium chloride (NaCl), which is particularly efficient for the borosilicate glasses. However, in certain applications, such as for glass tubing to be used as closed ampoule pharmaceutical packaging, the glass needs to contain a level of chloride (Cl) that is low enough to meet European Pharmacopoeia (EP) requirements. Per edition 10.4 of the European Pharmacopoeia, the test for chlorides for sterilized water for injections is a maximum 0.5 ppm for containers with a nominal volume of 100 mL or less. Therefore, when ampoules contain water for injection, the EP requirements allow for a maximum of 0.5 ppm Cl for containers having a nominal volume lower than 100 mL. Therefore, if NaCl is used as the fining agent for a borosilicate glass such as Corning 51-D borosilicate glass tubing (Corning Incorporated, Corning, N.Y.), the batched Cl level is limited to 0.03 wt %.

To address fining of borosilicate glasses with a low chloride (Cl) content, conventional fining techniques use fining agents such as As₂O₃, Sb₂O₃, F, CeO₂, or SnO₂. However, when fining glass for pharmaceutical applications, As₂O₃ and Sb₂O₃ are typically avoided. As such, the conventional fining package used for borosilicate glass to be used for pharmaceutical applications, such as the Corning 51-D borosilicate glass tubing (Corning Incorporated, Corning, N.Y.), is complex and includes four fining agents. The four fining agents in the conventional fining package may include SnO₂, CeO₂, F, and Cl. Despite the complexity, the fining quality is significantly lower compared to borosilicate glass fined with NaCl.

However, such a fining package is complex, requiring several raw materials, which leads to increased expenses when compared to NaCl as a fining agent. For example, SnO₂ comes from an expensive raw material. As such, a need exists for a simpler, lower-cost fining package for use with pharmaceutical applications which maintains the fining performance achieved by the conventional fining package and also achieves the glass and product properties necessary for pharmaceutical applications.

In embodiments of this disclosure, a simple, low-cost fining package is provided. The fining package may be used for fining of glass. Aspects of the fining package described herein may be used with glass compositions. In embodiments, the glass composition comprises a borosilicate glass composition. In embodiments, the glass composition comprises an aluminosilicate glass composition.

In embodiments, glass compositions using fining packages as described herein may be used to form glass tubing. In embodiments, the glass tubing formed from glass compositions that use fining packages as described herein may be used for pharmaceutical packaging. In embodiments, the pharmaceutical packaging may comprise vials, ampoules, catridges, or syringes. Nonlimiting examples of clear borosilicate glass tubing are Corning 33 and 51-D borosilicate glass tubing (Corning Incorporated, Corning, NY). A nonlimiting example of a clear aluminosilicate glass vial is the Corning Valor® glass vial (Corning Incorporated, Corning, NY).

Nonlimiting examples of glass compositions are described in U.S. Patent Application Publication No. 2014/0001076, U.S. Patent Application Publication No. 2014/0001143, U.S. Patent Application Publication No. 2014/0151320, U.S. Patent Application Publication No. 2014/0151321, U.S. Patent Application Publication No. 2014/0151370, U.S. Pat. Nos. 9,034,442, and 9,428,302, each of which are hereby incorporated by reference in its entirety.

Embodiments described herein include fining packages including the element sulfur (S), specifically in the form of alkali and alkaline earth sulfates. Sulfate fining has been used in the soda-lime glass industry where, for example, Na₂SO₄ is used in conjunction with a reducing agent, such as sugar or graphite, to break down the sulfate and release gases that help fine the glass. In the batch pile, most or all of the Na₂SO₄ is converted to Na₂S+2O₂. This conversion process can help gas escape at low temperatures (e.g., below 1000° C.), which fluffs the batch producing less bubbles in the final glass. The Na₂S decomposes between 1200° C. and 1400° C., and fines the relatively low temperature soda lime glass. However, other glass compositions are fined at significantly higher temperatures. These higher fining temperatures may be about 1400° C., such as 1550° C. or higher, including 1650° C. or higher.

Embodiments described herein provide fining packages where one or more of the typical fining agents (e.g., F, Cl, Sn, Ce, etc.) are removed and replaced with only S-bearing compounds, or with a mixture of S-bearing compounds and multivalent compounds (including, e.g., Sn, Ce, Fe, etc.) and/or one or more oxidizers (e.g., a nitrate). The fining packages with sulfate and optionally oxides have the following advantages: (1) they fine as or more effectively than traditional multivalent elements; (2) they drastically reduce the amount and cost of the fining agent used by eliminating the use of Sn, for example; (3) they produce a glass free of Cl as required by some end users and applications; (4) they lower the flux of volatile metals (e.g., Sn) from the glass; and (5) they reduce or eliminate color and/or loss of transmission.

Embodiments of this disclosure include fining packages having at least one S-bearing compound. The S-bearing compound may be a sulfate or sulfide. In embodiments, the fining package includes a sulfate and is sulfide-free. The sulfate may be an alkali sulfate or an alkaline earth sulfate. Nonlimiting examples include sodium sulfate (Na₂SO₄), potassium sulfate (KSO₄), calcium sulfate (CaSO₄), barium sulfate (BaSO₄), and strontium sulfate (Sr₅O₄). Embodiments may include an additional compound in the form of a multivalent compound in an amount from about 0.001 to about 1.0 mol %. Nonlimiting examples include Sn, Ce, and Fe compounds, including CeO₂, Sn₂, and Fe₂O₃.

Embodiments described herein provide a fining package comprising a low SnO₂ amount, compared to conventional fining packages. For example, a low amount of SnO₂ may be considered an amount less than about 0.3 wt %. In an embodiment, a lot amount of SnO₂ may be considered less than about 0.1 wt %.

Embodiments described herein also include fining packages with a sulfate, as described above, together with a nitrate. The nitrate may be used in an amount of from about 0.01% to about 0.1 mol % of the glass composition. It is believed that nitrate adds oxygen that can diffuse into bubbles, allowing them to grow in size, increasing rise rate, and fine from the melt faster, similar to the benefit of adding multivalent compounds. However, according to embodiments, fining packages may be free from a redox modifier, such as nitrate (oxidiezer) or carbon (reducer), to enhance fining.

Embodiments includes fining packages with a sulfate, but that is free of a reducing agent for reducing sulfate to sulfide. The fining package can be free of at least one of Cl, F, Sn, Ce, and As; or free from at least two of or at least three of Cl, F, Sn, Ce, and As. For fining package embodiments using heavy alkaline earth sulfates, similar or better performance may be observed with the addition of a reducing agent such as carbon or sugar, which is believed to cause a reaction of the sulfates (oxidized S) to sulfides (reduced S) and changes the breakdown temperature and kinetics of the chemical compound.

Sulfate is significantly cheaper than tin, and, according to embodiments herein, the levels of sulfate required for fining are lower than levels used in tin and halide fining, leading to cost savings and relief from pollution abatement problems, particularly at Vineland plant. Sulfate may be batched in a variety of forms, including sodium, calcium, or potassium, depending on the glass composition, adding flexibility and potentially additional cost savings. In addition, sulfate retention is in the low ppm level, resulting in a fining package that is transparent to customers.

The decomposition sulfate reaction, where “M” represents an alkali or alkaline earth element, is:

MSO₄(s)→MO(s)+SO₂(g)+½O₂(g)

(M=Na, K, Ca, Sr, Ba) with both the sulfur and oxygen forming dissolved gasses in the glass melt (this reaction occurs above 1400° C.; at lower temperatures carbon is used to promote decomposition of the sulfate). These gasses then diffuse into existing bubbles, resulting in bubble growth and Stokes fining as these bubbles enter the fining region of the glass melting tank. The fining region is higher in temperature than the melt zone, typically by 50-100° C., which further promotes bubble growth and rise, and thus Stokes fining. Thus, the entire fining process consists of three phases: (1) a chemical component, breakdown of sulfate into sulfur and oxygen gas compounds; (2) 2) a transport component, diffusion of gasses into existing bubbles; and (3) a physical component, bubble growth and rise commonly referred to as Stokes fining.

Multivalents, such as CeO₂, SnO₂, or Fe₂O₃ may be added to provide additional oxygen to the melt, further enhancing the fining process. For example, CeO₂ breaks down to Ce₂O₃ and O₂ by the reaction:

2CeO₂→Ce₂O₃+½O₂

supplying additional oxygen that may diffuse into the bubbles and assist fining. The range of batched CeO₂ is 0.01 to 0.1% mol, typically less than 0.06% mol. SnO₂ fining is a similar reaction:

SnO₂→SnO+½O₂

Neither tin nor cerium are particularly powerful fining agents on their own. The decision of which to use to assist fining is largely dependent on temperature with cerium more effective at lower temperatures (below 1550° C.) and tin more effective at higher temperatures (above 1550° C.).

A simple fining package with fewer components is beneficial for batch mixing. For example, it is advantageous to have fewer raw materials to store and weigh before mixing, preparation, and introduction into the industrial production tank. Such a glass composition allows for cost savings on the raw materials. The simplification of the fining package also allows for further development and a mechanistic understanding of the remaining fining agents.

By way of example, various glass compositions and fining packages are shown in Tables 1-5 as examples of embodiments of this disclosure. Tables 1 and 2 show aluminosilicate glass compositions with a variety of fining packages, according to embodiments of this disclosure. Tables 3, 4, and 5 show borosilicate glass compositions with a variety of fining packages, according to embodiments of this disclosure. These examples are in no way intended to be limiting on the embodiments of this disclosure, and are only provided as working examples that illustrate aspects of embodiments disclosed herein.

TABLE 1
Glass compositions and fining packages.

| | Sample (mol %) | C1 | C2 | C3 | C4 | C5 | C6 | C7 | C8 | C9 | C10 | C11 |
|---|---|---|---|---|---|---|---|---|---|---|---|---|
| Glass | SiO2 | 76.30 | 76.30 | 76.30 | 76.30 | 76.30 | 76.30 | 76.30 | 76.30 | 76.30 | 76.30 | 76.30 |
| | Al2O3 | 6.35 | 6.35 | 6.35 | 6.35 | 6.35 | 6.35 | 6.35 | 6.35 | 6.35 | 6.35 | 6.35 |
| | Na2O | 11.56 | 11.56 | 11.69 | 11.69 | 11.69 | 11.69 | 11.69 | 11.69 | 11.69 | 11.69 | 11.69 |
| | MgO | 5.30 | 5.30 | 5.30 | 5.30 | 5.30 | 5.30 | 5.30 | 5.30 | 5.30 | 5.30 | 5.30 |
| | CaO | 0.16 | 0.16 | 0.16 | 0.16 | 0.16 | 0.16 | 0.16 | 0.16 | 0.16 | 0.16 | 0.16 |
| Fining | SnO2 | 0.20 | 0.20 | 0 | 0 | 0 | 0 | 0 | 0 | 0 | 0 | 0 |
| | NaNO2 | 0.13 | 0.13 | 0 | 0 | 0 | 0 | 0 | 0 | 0 | 0 | 0 |
| | NaSO4 | 0 | 0 | 0 | 0.02 | 0.03 | 0.1 | 0 | 0 | 0 | 0 | 0 |
| | K2SO4 | 0 | 0 | 0 | 0 | 0 | 0 | 0.1 | 0 | 0 | 0 | 0 |
| | CaSO4 | 0 | 0 | 0 | 0 | 0 | 0 | 0 | 0.1 | 0 | 0 | 0 |
| | SrSO4 | 0 | 0 | 0 | 0 | 0 | 0 | 0 | 0 | 0.08 | 0.08 | 0 |
| | BaSO4 | 0 | 0 | 0 | 0 | 0 | 0 | 0 | 0 | 0 | 0 | 0.08 |
| | C | 0 | 0 | 0 | 0 | 0 | 0 | 0 | 0 | 0 | 0.0037 | 0 |
| | BaS | 0 | 0 | 0 | 0 | 0 | 0 | 0 | 0 | 0 | 0 | 0 |
| | SrS | 0 | 0 | 0 | 0 | 0 | 0 | 0 | 0 | 0 | 0 | 0 |
| | CeO2 | 0 | 0 | 0 | 0 | 0 | 0 | 0 | 0 | 0 | 0 | 0 |
| | Total | 100.00 | 100.00 | 99.80 | 99.82 | 99.83 | 99.90 | 99.90 | 99.90 | 99.88 | 99.88 | 99.88 |

As shown in Table 1, Samples C1 and C2 are aluminosilicate glass compositions fined with a combination of NaNO₂ and SnO₂. Sample C3 is a glass composition without fining agents. Samples C4-C11 show glass compositions with fining packages according to embodiments of this disclosure. In particular, Samples C4-C11 each use a sulfate (e.g., sulfates of Na, K, Ca, Sr, or Ba) either alone or, in the case of Sample C10, with a reducer (e.g., C). Specifically, Samples C4, C5, and C6 are fined with NaSO₄; Sample C7 with K₂SO₄; Sample C8 with CaSO₄; Sample C9 with SrSO₄; Sample C10 with SrSO₄ and C; and C11 with BaSO₄. The fining packages are all free of Cl, F, Sn, Ce, and As.

TABLE 2
Glass compositions and fining packages.

| | Sample (mol %) | C12 | C13 | C14 | C15 | C16 | C17 | C18 | C19 | C20 | C21 |
|---|---|---|---|---|---|---|---|---|---|---|---|
| Glass | SiO2 | 76.3 | 76.30 | 76.30 | 76.30 | 76.30 | 76.30 | 76.30 | 76.32 | 76.36 | 76.37 |
| | Al2O3 | 6.35 | 6.35 | 6.35 | 6.35 | 6.35 | 6.35 | 6.35 | 6.35 | 6.35 | 6.35 |
| | Na2O | 11.69 | 11.69 | 11.69 | 11.69 | 11.69 | 11.69 | 11.69 | 11.78 | 11.78 | 11.78 |
| | MgO | 5.3 | 5.30 | 5.30 | 5.30 | 5.30 | 5.30 | 5.30 | 5.30 | 5.30 | 5.30 |
| | CaO | 0.06 | 0.16 | 0.16 | 0.16 | 0.16 | 0.16 | 0.16 | 0.16 | 0.16 | 0.16 |
| Fining | SnO2 | 0 | 0 | 0 | 0 | 0 | 0.10 | 0 | 0.06 | 0.02 | 0.01 |
| | NaNO2 | 0 | 0 | 0 | 0 | 0 | 0 | 0 | 0 | 0 | 0 |
| | NaSO4 | 0 | 0 | 0 | 0 | 0 | 0.03 | 0.03 | 0.03 | 0.03 | 0.03 |
| | K2SO4 | 0 | 0 | 0 | 0 | 0 | 0 | 0 | 0 | 0 | 0 |
| | CaSO4 | 0 | 0 | 0 | 0 | 0 | 0 | 0 | 0 | 0 | 0 |
| | SrSO4 | 0 | 0.03 | 0 | 0 | 0 | 0 | 0 | 0 | 0 | 0 |
| | BaSO4 | 0.08 | 0 | 0.03 | 0 | 0 | 0 | 0 | 0 | 0 | 0 |
| | C | 0.0037 | 0 | 0 | 0 | 0 | 0 | 0 | 0 | 0 | 0 |
| | BaS | 0 | 0 | 0 | 0.1 | 0 | 0 | 0 | 0 | 0 | 0 |
| | SrS | 0 | 0 | 0 | 0 | 0.1 | 0 | 0 | 0 | 0 | 0 |
| | CeO2 | 0 | 0 | 0 | 0 | 0 | 0 | 0.08 | 0 | 0 | 0 |
| | Total | 99.78 | 99.83 | 99.83 | 99.90 | 99.90 | 99.93 | 99.91 | 100.00 | 100.00 | 100.00 |

As shown in Table 2, Samples C12 through C21 are aluminosilicate glass compositions with fining packages including one or more S-bearing compounds. In particular, the fining packages include one or more sulfates and/or sulfides. Specifically, for sulfate-containing fining packages, Samples C17-C21 include NaSO₄; Sample C13 includes SrSO₄; and Samples C12 and C14 include BaSO₄. Sample C12 additionally includes a reducer (i.e., C). Samples C17 and C19-C21 additionally include the multivalent compound SnO₂, and Sample C18 additionally includes the multivalent compound CeO₂. Samples C15 and C16 are fined with sulfides BaS and SrS, respectively. The fining packages from Samples C12-C16 are free of Cl, F, Sn, Ce, and As, and the remaining Samples C17-C21 include only small amounts of Cn and Ce as part of the multivalent compounds of the fining packages.

TABLE 3
Glass compositions and fining packages.

| | Sample (mol %) | C22 | C23 | C24 | C25 | C26 | C27 | C28 | C29 |
|---|---|---|---|---|---|---|---|---|---|
| Glass | SiO2 | 82.28 | 82.28 | 82.24 | 82.15 | 82.24 | 82.24 | 82.24 | 82.25 |
| | Al2O3 | 1.49 | 1.49 | 1.49 | 1.49 | 1.49 | 1.49 | 1.49 | 1.49 |
| | B2O3 | 11.57 | 11.57 | 11.56 | 11.55 | 11.57 | 11.57 | 11.57 | 11.56 |
| | Na2O (non- | 4.66 | 4.59 | 4.66 | 4.66 | 4.66 | 4.66 | 4.66 | 4.66 |
| | fining agent) | | | | | | | | |
| Fining | Na2O (NaCl) | 0 | 0.07 | 0 | 0 | 0 | 0 | 0 | 0 |
| | Na2O (Na2SO4) | 0 | 0 | 0.05 | 0.05 | 0 | 0 | 0 | 0 |
| | SnO2 | 0 | 0 | 0 | 0.1 | 0.05 | 0 | 0 | 0 |
| | BaO (BaS) | 0 | 0 | 0 | 0 | 0 | 0.05 | 0 | 0 |
| | BaO (BaSO4) | 0 | 0 | 0 | 0 | 0 | 0 | 0.05 | 0 |
| | SrO (SrSO4) | 0 | 0 | 0 | 0 | 0 | 0 | 0 | 0.05 |
| | Total | 100 | 100 | 100 | 100 | 100 | 100 | 100 | 100 |

Table 3 shows examples of borosilicate glass compositions and fining packages. As comparative examples to embodiments of this disclosure, Sample C22 is a composition without any fining agent, and Sample C23 using a conventional NaCl fining package. Samples C24 and C25 use Na₂SO₄, with Sample C25 additionally including SnO₂. Samples C28 and C29 also use sulfates in the form of BaSO₄ and SrSO₄, respectively. As a comparative example, Sample C26 uses SnO₂, which is a typical fining agent. Sample C27 uses BaS.

TABLE 4
Glass compositions and fining packages.

| | Sample (mol %) | C30 | C31 | C32 | C33 |
|---|---|---|---|---|---|
| Glass | SiO2 | 75.16 | 75.16 | 75.16 | 75.16 |
| | Al2O3 | 4.03 | 4.03 | 4.03 | 4.03 |
| | B2O3 | 10.03 | 10.03 | 10.03 | 10.03 |
| | Na2O (non-fining | 6.98 | 6.98 | 6.98 | 6.98 |
| | agent) | | | | |
| | K2O | 0.74 | 0.74 | 0.74 | 0.74 |
| | CaO | 1.46 | 1.46 | 1.46 | 1.46 |
| Fining | Na2O (Na2SO4) | 0.1 | 0 | 0 | 0 |
| | SnO2 | 0 | 0 | 0 | 0.05 |
| | Cl— | 0 | 0 | 0 | 0.04 |
| | F— | 0 | 0 | 0 | 0.79 |
| | CeO2 | 0 | 0 | 0 | 0.06 |
| | CaO (CaSO4) | 0 | 0.1 | 0 | 0 |
| | K2O (K2SO4) | 0 | 0 | 0.1 | 0 |
| | Total | 98.5 | 98.5 | 98.5 | 99.34 |

Table 4 shows examples of borosilicate glass compositions and fining packages. Samples C30, C31, and C32 are sulfate fined using Na₂SO₄, CaSO₄, and K₂SO₄, respectively, and without Sn, Cl, F, or Ce. As a comparative example to embodiments of this disclosure, Sample C33 is a composition using a conventional fining package that includes Sn, Cl, F, and Ce.

TABLE 5
Glass compositions and fining packages.

| | Sample (mol %) | C34 | C35 | C36 | C37 |
|---|---|---|---|---|---|
| Glass | SiO2 | 75.607 | 76.313 | 76.35 | 75.73 |
| | Al2O3 | 4.05 | 4.09 | 4.09 | 4.05 |
| | B2O3 | 10.08 | 10.18 | 10.19 | 10.07 |
| | Na2O | 7.12 | 7.14 | 7.04 | 7.11 |
| | K2O | 0.74 | 0.75 | 0.75 | 0.74 |
| | MgO | 0.007 | 0.007 | 0.007 | 0.007 |
| | CaO | 1.46 | 1.47 | 1.47 | 1.46 |
| Fining | Na2SO4 | 0 | 0.05 | 0.05 | 0 |
| | NaNO3 | 0 | 0 | 0.05 | 0 |
| | Cl | 0.036 | 0 | 0 | 0.035 |
| | F | 0.79 | 0 | 0 | 0.70 |
| | CeO2 | 0.06 | 0 | 0 | 0.05 |
| | SnO2 | 0.05 | 0 | 0 | 0.05 |
| | total | 100.00 | 100.00 | 100.00 | 100.00 |

As shown above in Table 5, Sample C35, like Sample C30 above, is fined with sodium sulfate; Sample C36 is sodium sulfate fined with sodium nitrate; and Samples C34 and C37 are comparative examples showing conventional fining packages using chlorine, fluorine, cerium, and tin.

Fining packages according to embodiments of this disclosure can completely eliminate all the current fining agents used in the contemplated glass compositions, with the possible exception of Ce in some embodiments, and replaces them with a variation of a sulfate and, optionally, a redox modifier package commonly used in the float and container glass industries, but modified for the borosilicate glass compositions and higher temperature melting and fining.

### EXPERIMENTAL RESULTS

Glass Preparation, Seeds Counting and Solids Analysis

Glass samples where prepared using both static and continuous forming techniques. For the static forming, noble metal crucibles capable of containing between about 0.5 kg and 1.5 kg of molten glass were used. Temperatures used ranged from 1350-1500° C. for loading, 1450-1600° C. for melting, and 1500-1650° C. for fining. Melts were then either annealed in their crucible and core drilled, or poured onto a steel table. Defects were counted on core-drilled samples and quenched melt pours were examined optically and chemically. Select compositions were studied on a continuous melting platform to investigate the scale-up viability of these alternative fining packages. The continuous melting experiments helped to ensure successful assessment of the performance of fining packages according to embodiments of this disclosure. The continuous experiments were conducted over the course of 6 days on a noble metal melting platform with a continuous feeding system that produces glass strip at a rate of 10-15 lbs/hr. Temperatures in in the continuous forming experiments ranged from 1500° C. to 1600° C. for melting and 1550° C. to 1650° C. for fining. Defects were counted on glass strip samples collected throughout each continuous experiment at regular intervals.

For borosilicate glass compositions such as the examples shown in Table 4 and 5 above, observations of the melting, fining, and glass quality from two continuous forming experiments that sampled the melting and fining performance through the process by strategic sampling/measurements and after the melt was quenched indicate that the sulfate solution results do scale up to a continuous process, and is less aggressive or harmful to glass tank refractory materials.

For the boron-free aluminosilicate glasses, such as the examples shown in Tables 1-3 above, observations and sampling of melting, fining, and glass quality from one continuous forming experiment indicates that the sulfate solution results are improved on a continuous process. According to embodiments, sulfate is a viable tin replacement for several reasons: (i) Sn vaporization and condensation during the tube-to-container (e.g., vial or other pharmaceutical packaging) conversion can cause cosmetic defects, (ii) Sn can be the or one of the most expensive batch materials in these glass compositions, and (iii) some users or fillers of pharmaceutical packaging are hesitant to include Sn as part of their drug packaging.

Characterizations of Glass Composition and Properties

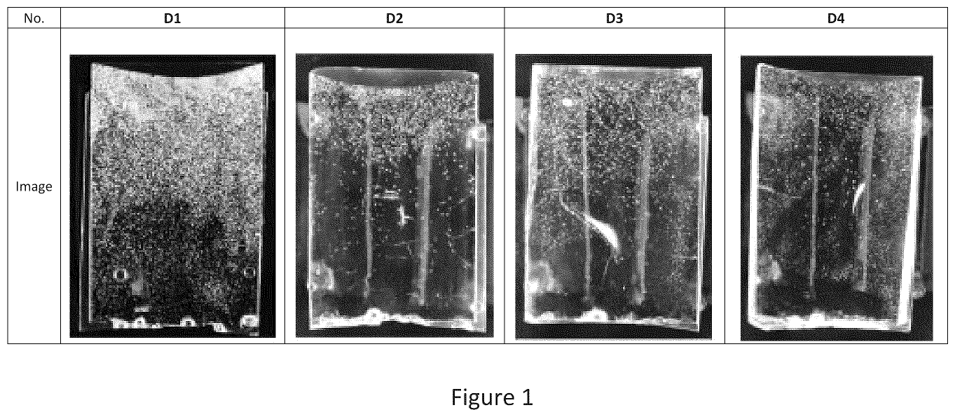

FIG. 1 shows a comparison table with four images of crucible melt center core slices of borosilicate glass compositions. The melt temperature and time for all samples was 1500° C. for 1 hour, respectively, and the fining temperature was 1550° C. for a time of 30 minutes. Sample D1 contained no fining package, whereas Samples D2, D3, and D4 used Na₂SO₄ in amounts f 0.05, 0.1, and 0.2 mol %, respectively. All samples also used 0.1 mol % nitrate. A visual comparison of Samples D2-D4 to Sample D1 shows significantly fewer seeds in the sulfate-fined glasses as compared to the glass containing no fining agent.

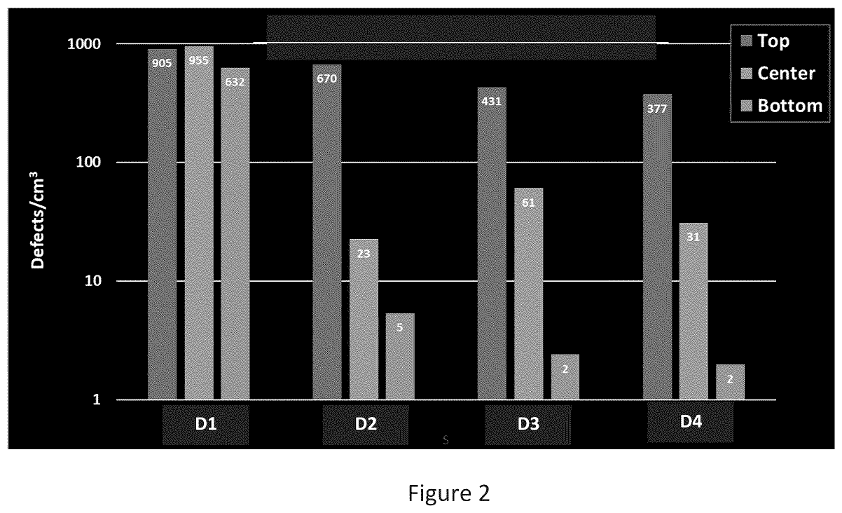

FIG. 2 shows a bar graph comparing the defects per cm³ at three locations (top, middle, and bottom) in each of Samples D1-D4 from FIG. 1. The blisters or defects per cm³ are plotted on a log scale. Note the melt composition with no fining agent (D1) contains a large numbers of bubbles throughout the entire glass core slice, whereas the glasses fined with sodium sulfate contained blisters towards the top of the melt, but much fewer blisters in the center and lower sections of the melt, indicating the fining action of the sulfate.

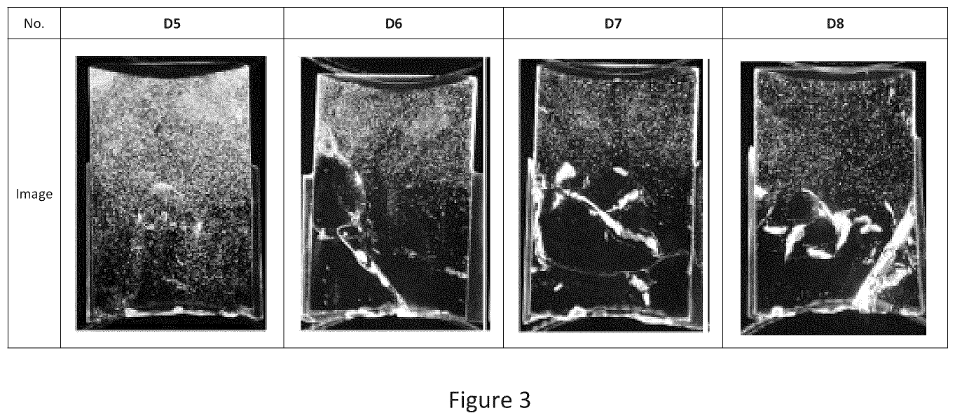

FIG. 3 shows a comparison table with four images of crucible melt center core slices of borosilicate glass compositions with 0.1 mol % nitrate, and with no fining agent (Sample D5) compared to 0.05 mol % sodium sulfate (Na₂SO₄) (Sample D6), 0.05 mol % potassium sulfate (K₂SO₄) (Sample D7), and 0.05 mol % calcium sulfate (CaSO₄) (Sample D8). The melt temperature and time for all samples was 1500° C. for 1 hour, respectively, and the fining temperature was 1550° C. for a time of 30 minutes. As seen in FIG. 1, FIG. 3 shows many more seeds visible in Sample D5 with no fining agent compared to the sulfate-fined glass in Samples D6-D8.

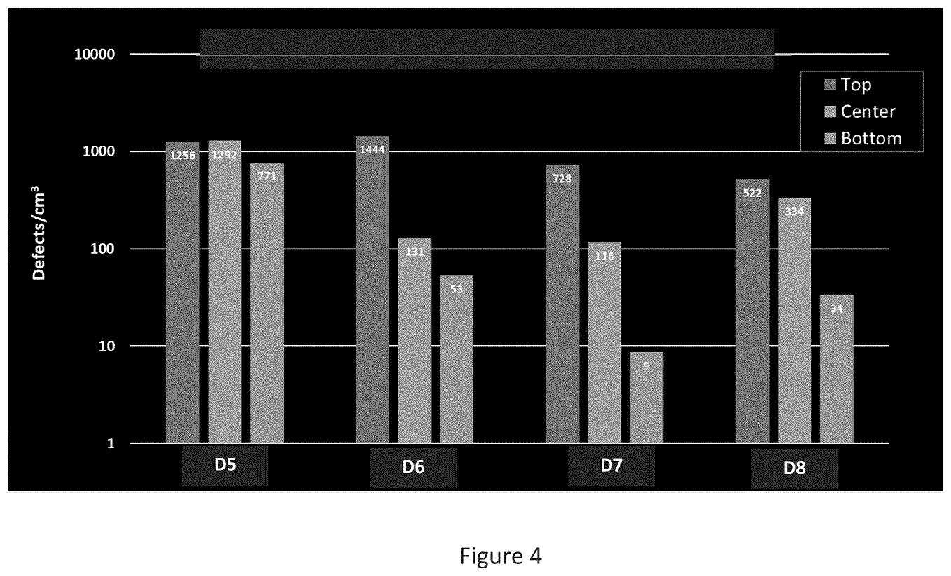

FIG. 4 shows a bar graph comparing the defects per cm₃ at three locations (top, middle, and bottom) in each of Samples D5-D8 from FIG. 3. The blisters or defects per cm³ are plotted on a log scale. Note the melt composition with no fining agent (D5) contains a large numbers of bubbles throughout the entire glass core slice, whereas the glasses fined with sulfates contained fewer blisters.

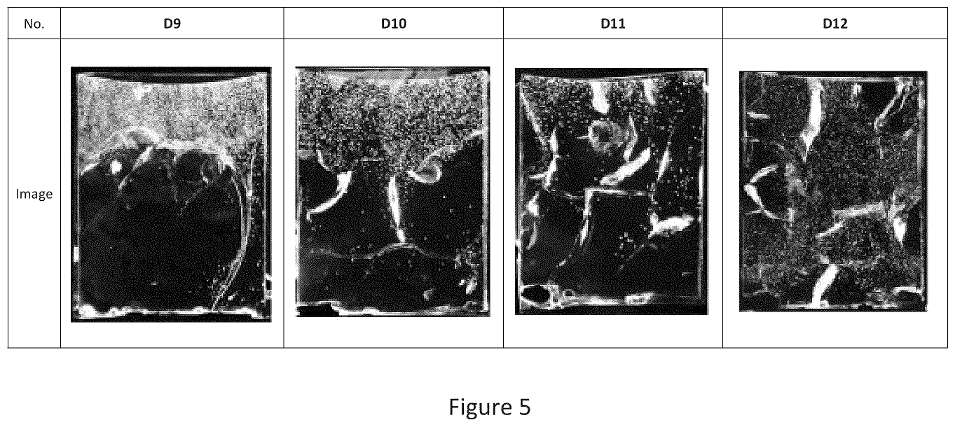

FIG. 5 shows a comparison table with four images of crucible melt center core slices of borosilicate glass compositions without nitrate (Samples D9-D12). The melt temperature and time for all samples was 1450° C. for 90 minutes, respectively, and the fining temperature was 1550° C. for a time of 120 minutes and then cooled to 1400° C. for 1 hour. Samples D9, D10, and D11 were fined with sulfates, whereas D12 was fined with a conventional fining package, for comparison. Specifically, Sample D9 used 0.05 mol % sodium sulfate; Sample D10 used 0.05 mol % sodium sulfate and 0.03% cerium oxide; and D11 used 0.05 mol % sodium sulfate and 0.06 mol % cerium oxide. Comparative Sample D12 used a fining package with Cl, F, Ce, and Sn. Note blisters throughout the core in Sample D12, indicating very little fining when using the fining package with 0.04 mol % Cl, 0.79 mol % F, 0.06 mol % Ce, and 0.05 mol % Sn. In the two ceria-containing melts, it is believed that the ceria assists the sulfate by supplying additional O₂ to help grow bubbles, assisting Stokes fining by faster bubble rise.

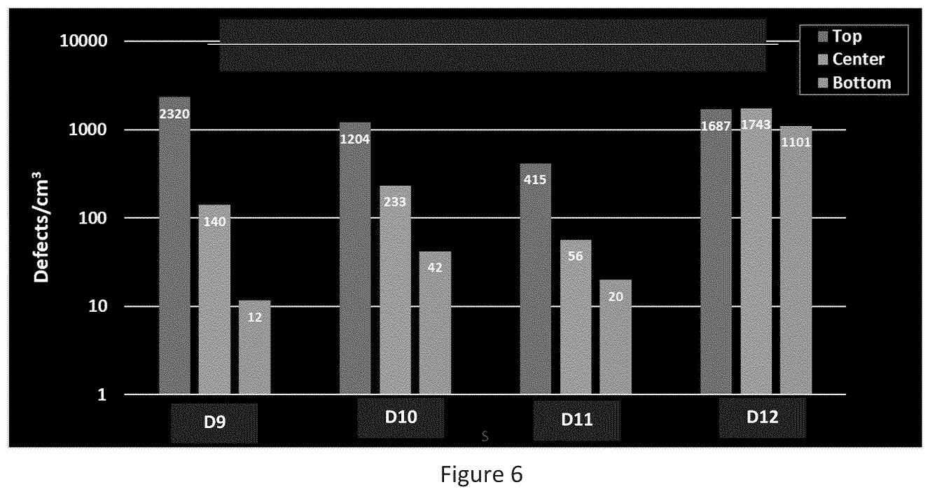

FIG. 6 shows a bar graph comparing the defects per cm³ at three locations (top, middle, and bottom) in each of Samples D9-D12 from FIG. 5. The blisters or defects per cm³ are plotted on a log scale. Note the melt composition with the Sn-Ce-F—Cl fining package (D12) contains a large numbers of bubbles throughout the entire glass core slice, whereas the glasses fined with sulfates contained much fewer blisters.

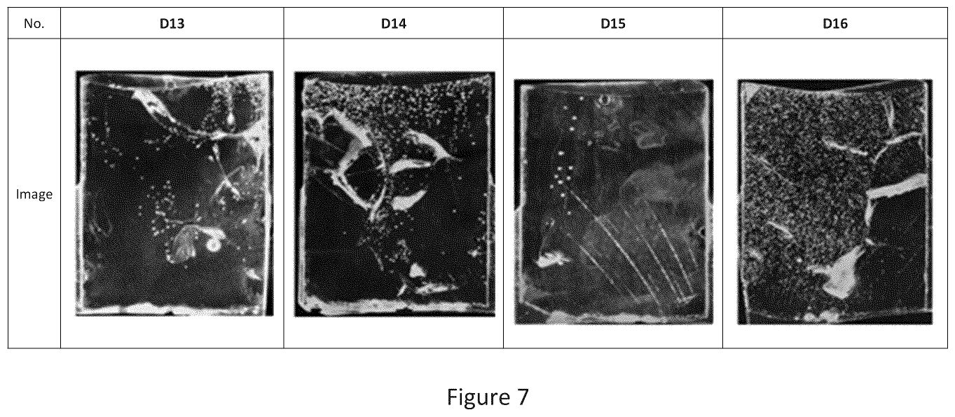

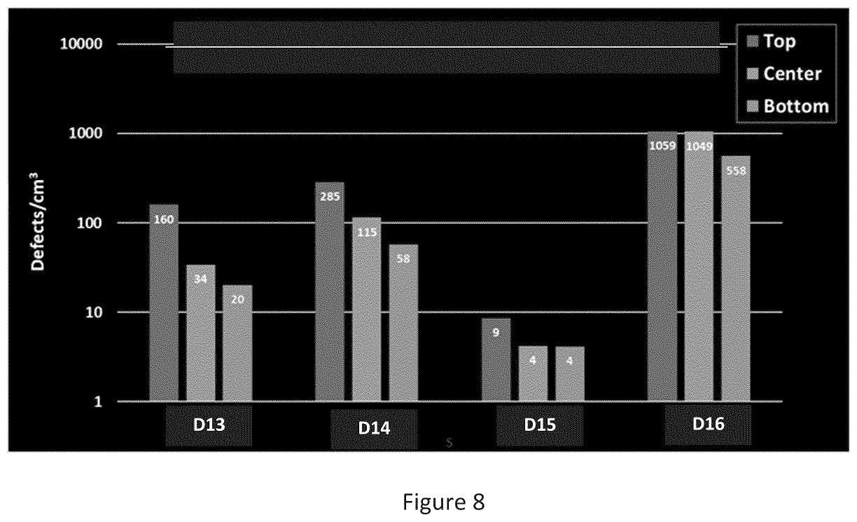

FIG. 7 shows a comparison table with four images of crucible melt center core slices of borosilicate glass compositions without nitrate (Samples D13-D16). The melt temperature and time for all samples was 1450° C. for 90 minutes, respectively, and the fining temperature was 1550° C. for a time of 120 minutes and then cooled to 1400° C. for 1 hour. Samples D13, D14, and D15 were fined with sulfates, whereas D16 was fined with a conventional fining package, for comparison. Specifically, Sample D13 used 0.1 mol % sodium sulfate; Sample D14 used 0.1 mol % sodium sulfate and 0.03% cerium oxide; and D15 used 0.1 mol % sodium sulfate and 0.06 mol % cerium oxide. Comparative Sample D16 used a fining package with Cl, F, Ce, and Sn. Note blisters throughout the core in Sample D16, indicating very little fining when using the fining package with 0.04 mol % Cl, 0.79 mol % F, 0.06 mol % Ce, and 0.05 mol % Sn. This melt demonstrates that doubling the sulfate from 0.05 mol % (see, e.g., the images from FIGS. 1, 3, and 5; and also FIGS. 2, 4, and 6) to 0.1 mol % reduced the number of blisters in the melt, as shown in FIG. 7 and in the graph of FIG. 8.

FIG. 8 shows a bar graph comparing the defects per cm³ at three locations (top, middle, and bottom) in each of Samples D13-D16 from FIG. 7. The blisters or defects per cm³ are plotted on a log scale. Note the melt composition with the Sn-Ce-F—Cl fining package (D16) contains a large numbers of bubbles throughout the entire glass core slice, whereas the glasses fined with sulfates (D13-D15) contained much fewer blisters at all locations. These defect counts demonstrate that doubling the sulfate from 0.05 mol % to 0.1 mol % did indeed reduce the number of blisters in the melt.

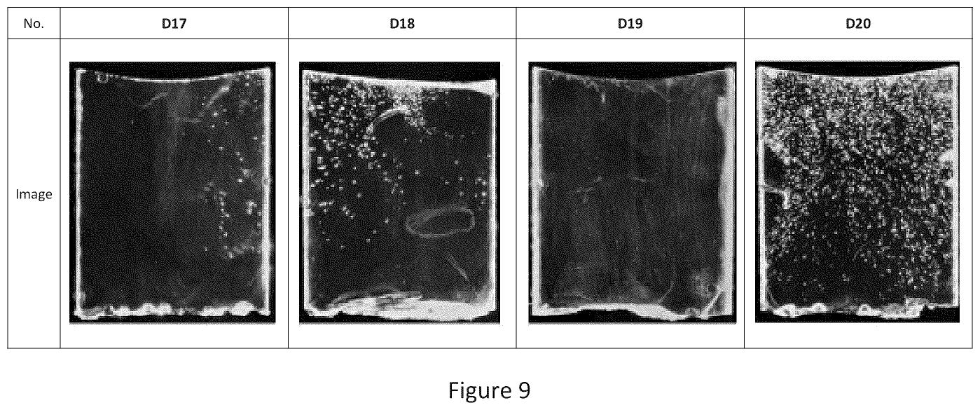

FIG. 9 shows a comparison table with four images of crucible melt center core slices of borosilicate glass compositions without nitrate (Samples D17-D20). The melt temperature and time for all samples was 1450° C. for 90 minutes, respectively, and the fining temperature was 1550° C. for a time of 120 minutes and then cooled to 1400° C. for 1 hour. Samples D17, D18, and D19 were fined with sulfates, whereas D20 was fined with a conventional fining package, for comparison. Specifically, Sample D17 used 0.1 mol % sodium sulfate; Sample D18 used 0.1 mol % calcium sulfate; and D19 used 0.1 mol % potassium sulfate. Comparative Sample D20 used a fining package with 0.04 mol % Cl, 0.79 mol % F, 0.06 mol % Ce, and 0.05 mol % Sn. Note blisters throughout the core in Sample D20, indicating very little fining when using the fining package with Cl, F, Ce, and Sn. This melt again demonstrates that effect of doubling the sulfate from 0.05 mol % to 0.1 mol %. In addition, while the above samples used a fine sand with a D50 particle size of 154 microns, the samples in FIG. 9 used a coarser sand with a D50 particle size of 352 microns (e.g., Crystal sand from Sibelco), which is a more than 200 micron increase in average particle size. The coarser sand resulted in improved fining with the sulfate fining packages. Unless otherwise stated, the examples shown herein use the fine sand (e.g., a D50 particle size of 154 microns). This benefit was not observed in crucible melts with the Sn-Ce-F—Cl fining package. The improvement may result from slower melting of the silica resulting in a slower bubble generation rate, allowing bubbles to be removed without overwhelming the fining package, and less foaming of the batch combined with the surfactant effect of sulfates coating the sand grains and preventing them from sticking together. The sulfates may be acting as surfactants in the melts, preventing agglomeration of the sand grains, thus aiding in melting.

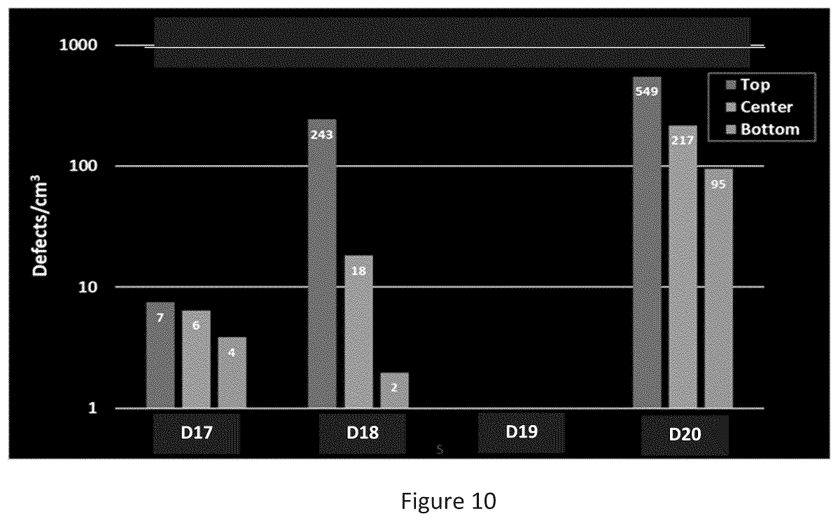

FIG. 10 shows a bar graph comparing the defects per cm³ at three locations (top, middle, and bottom) in each of Samples D17-D20 from FIG. 9. The blisters or defects per cm³ are plotted on a log scale. Note the melt composition with the Sn-Ce-F—Cl fining package (D20) contains a large numbers of bubbles throughout the entire glass core slice, whereas the glasses fined with sulfates (D17-D19) contained much fewer blisters at all locations. These melts demonstrate the impact of sulfate fining with a coarser sand. In fact, D19 was completely fined with no remaining blisters. The sodium sulfate fining package in D17 also resulted in very few blisters.

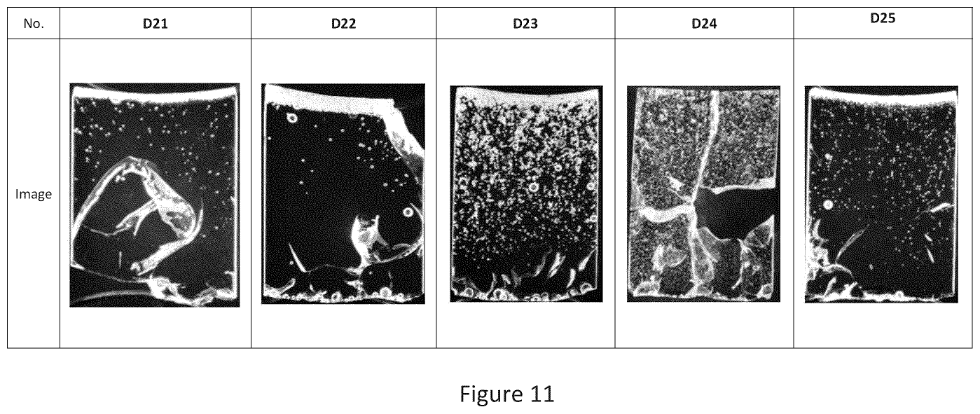

FIG. 11 shows a comparison table with five images of crucible melt center core slices of boron-free aluminosilicate glass compositions (Samples D21-D25). Sample D25 was fined with Na₂SO₄, Sample D21 with Na₂SO₄ and Ce, and Sample D22 with Na₂SO₄ and Sn. Each of D21, D22, and D25 show fewer remaining bubbles than in D23, which uses a conventional SnO₂ fining package. When counted, the defects/cm³ also show that the Na₂SO₄, Na₂SO₄+Ce, and Na₂SO₄+Sn fining packages all have fewer defects than the conventional SnO₂ fining package used in D23. For comparison, no fining was used in Sample D24, which resulted in voids throughout.

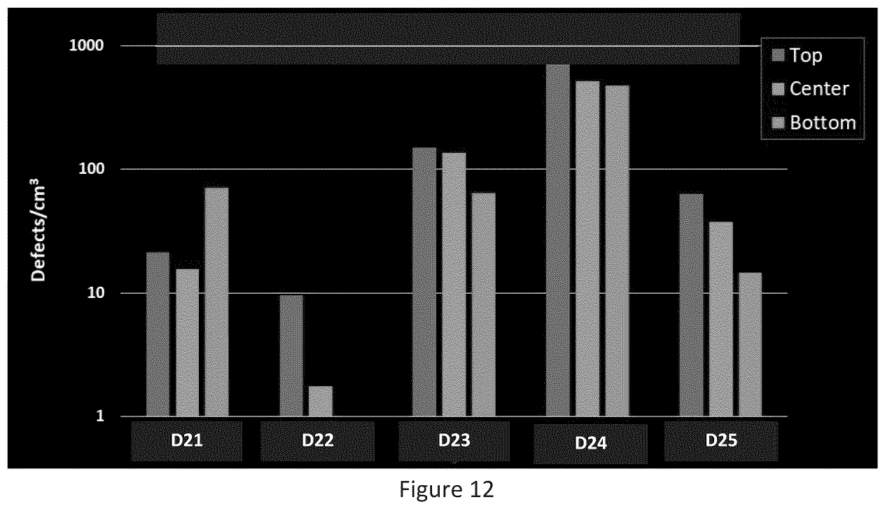

FIG. 12 shows a bar graph comparing the defects per cm³ at three locations (top, middle, and bottom) in each of Samples D21-D25 from FIG. 11. The blisters or defects per cm³ are plotted on a log scale. Note the melt composition with no fining package (D24) contains a large numbers of bubbles throughout the entire glass core slice, and the conventional SnO₂ package also has a higher number of voids throughout compared to the sulfate-fined melts.

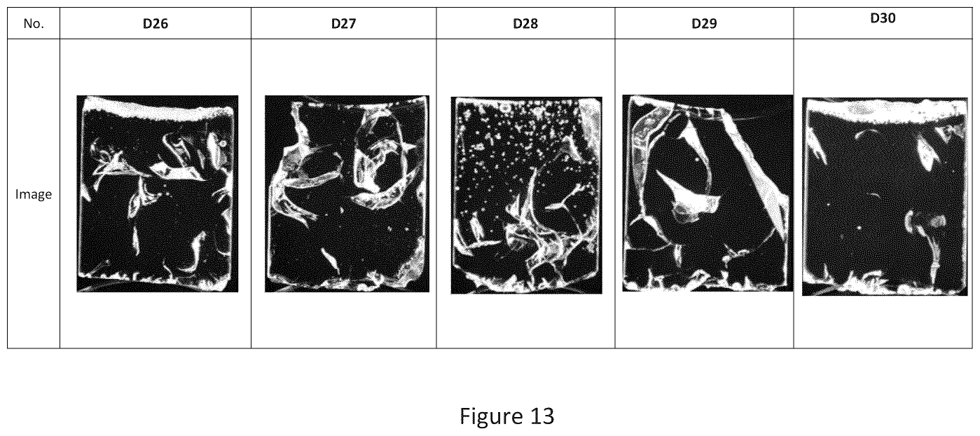

FIG. 13 shows a comparison table with five images of crucible melt center core slices of boron-free aluminosilicate glass compositions (Samples D26-D30). Sample D26 was fined with BaSO₄ with carbon, Sample D27 was fined with BaSO₄ without carbon, Sample D29 with SrSO₄ with carbon, and Sample D30 with SrSO₄ without carbon. Comparative Sample D28 contained no fining package and showed poorer results with more defects that D26, D27, D29, and D30.

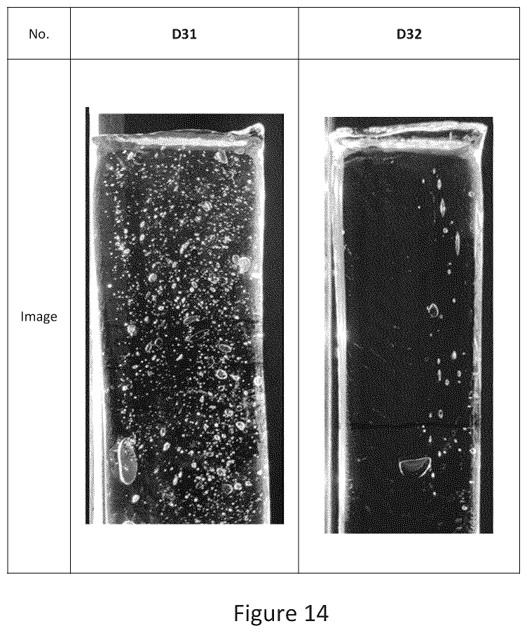

FIG. 14 shows a comparison table with two images of borosilicate glass strips formed using the continuous melting platform: Samples D31 and D32. Sample D31 was fined using the Cl—F-Ce-Sn fining packaged discussed in the above examples. Sample D32 was fined with 0.1 mol % sodium sulfate with nitrate. A visual comparison demonstrates the improved glass quality of the sulfate fining package on the continuous melting process. An analysis of defects showed between 30,000 and 60,000 defects per pound of glass for the glass fined with the Cl—F-Ce-Sn package. The glass fined with sulfate and nitrate had between zero and 3,000 defects per pound of glass. This experiment quantifies the improved glass quality of the sulfate fining package on a continuous process that is not necessarily captured in static experiments and provides support for the use of the fining packages disclosed herein in large-scale tanks with continuous processes. When using a coarser sand, such as one with a D50 particle size of 352 microns, the defects per pound for the sulfate fined glass decreased to from zero to 500 defects per pound.

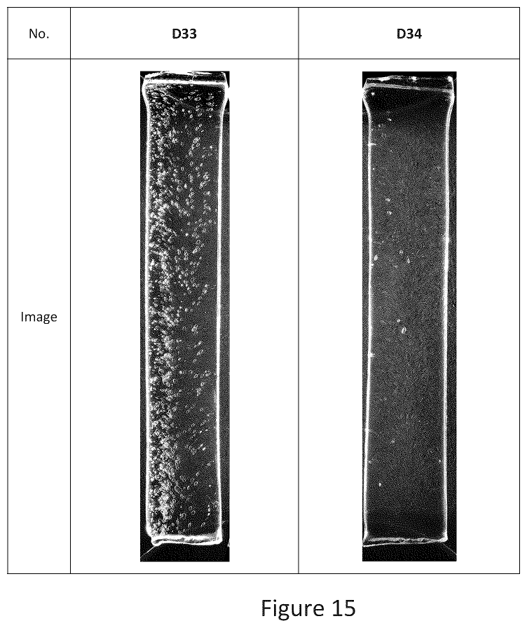

FIG. 15 shows a comparison table with two images of boron-free aluminosilicate glass strips formed using the continuous melting platform: Samples D33 and D34. Sample D33 was fined using a conventional 0.2 mol % tin fining package, whereas Sample D34 was fined using a 0.03 mol % sodium sulfate with 0.1 mol % tin fining package. The comparison shown demonstrates the improved glass quality of the sulfate fining package on a continuous process for the aluminosilicate glass. An analysis of defects showed between 5,000 and 25,000 defects per pound of glass for the glass fined with the conventional tin fining package. The glass fined with sulfate and tin had between zero and 1,000 defects per pound of glass. This experiment again quantifies the improved glass quality of the sulfate fining package on a continuous process that is not necessarily captured in static experiments and provides support for the use of the fining packages disclosed herein in large-scale tanks with continuous processes.

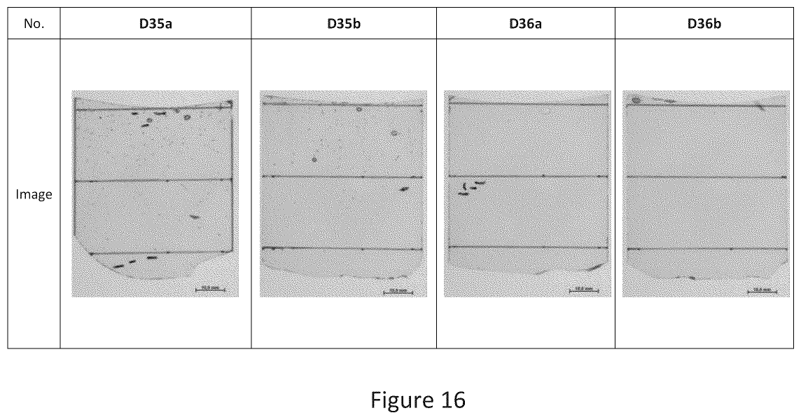

For the following examples, results of which are shown in FIGS. 16-22, the following experimental setup was used. An appropriate amount of raw materials to obtain 1000 g of glass was set in 4 platinum crucibles and melted in an electrical furnace heated by Globar® heating elements under ambient air. The glass compositions are indicated in Table 5. For the melting cycle, the crucibles are introduced in the furnace preheated at 1450° C., where they are held for 1 hour at 1450° C. They are then heated for 150 minutes from 1450° C. to 1550° C., and then held at 1550° C. during a dwell time labeled D. The crucibles are pulled out at 1550° C. To get an average result due to thermal inhomogeneity in the furnace, each glass composition was measured twice (i.e., two crucibles labeled with the suffix “−1” and “−2”). After melting, the glasses are annealed in the crucibles for 2 hours at 600° C. and subsequently cooled down slowly. Samples with diameters of 50-60 mm are core drilled from the glass in the crucible and from each sample one 3-mm-thick vertical slice is taken from the center and polished. Seeds are counted at 3 distances from the glass surface: 0, 2.5 and 5 mm and their number are normalized by the involved glass volume (about 0.5 cubic centimeter (cm³)). The solids are counted at the same 3 distances from the glass surface and the solid size is measured individually. With the average diameter and the number of solids the total volume of solids is calculated.

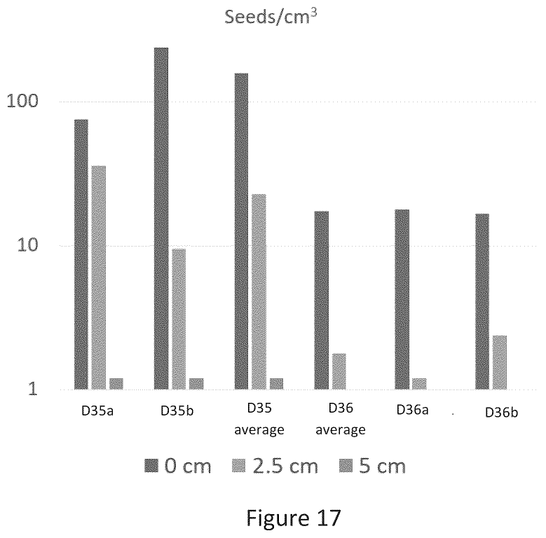

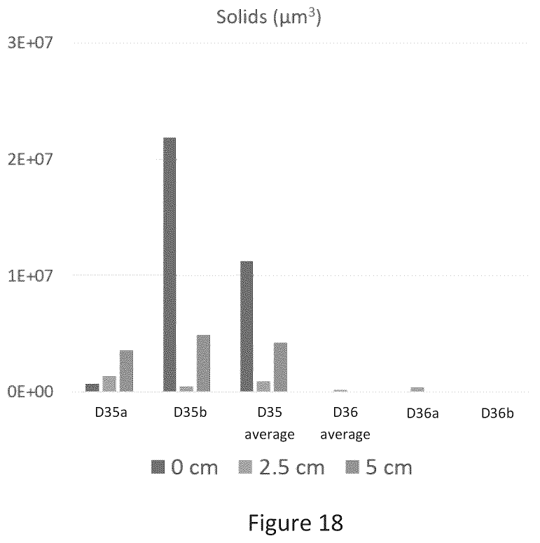

FIG. 16 shows a comparison table with four images of core-drilled samples of borosilicate glass formed in crucibles: Samples D35a, D35b, D36a, and D36b. The D35 samples correspond to Sample C34 from Table 5, and were fined with the above-discussed conventional Cl—F-Ce-Sn package. The D36 samples correspond to Sample C35 from Table 5 and were fined with sodium sulfate. FIG. 17 shows a bar graph comparing the seeds per cm³ of the samples from FIG. 16, and FIG. 18 shows a bar graph comparing the solids per μm³ of the same. As shown, the sulfate-fined samples (D36a and D36b) have fewer remaining bubbles than the samples fined with the Cl—F-Ce-Sn package (D35a and D35b). The averages for the D35 and the D36 samples is also shown.

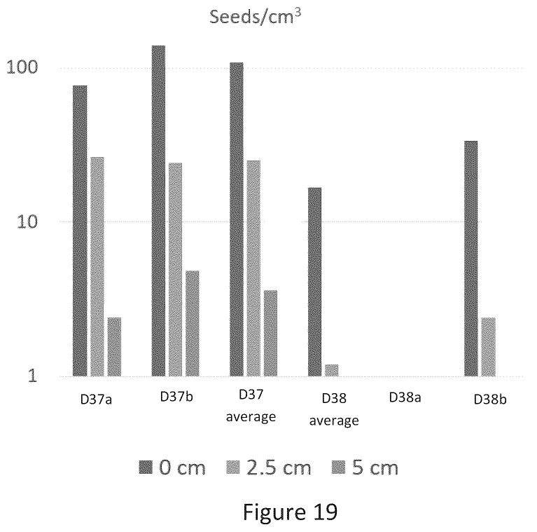

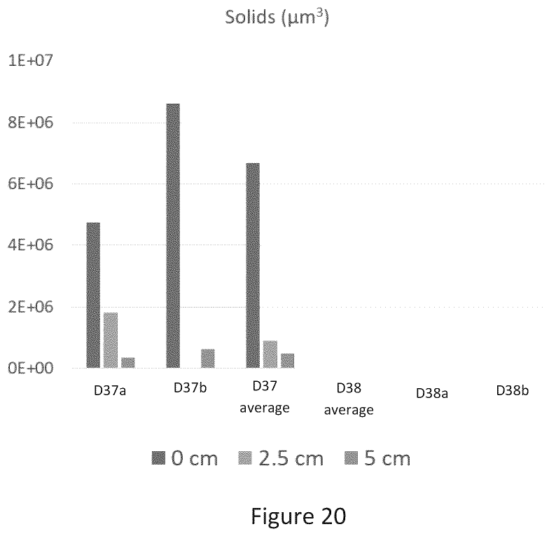

FIGS. 19 and 20 show bar graphs comparing Samples D37a and D37b (again corresponding to Sample C34 from Table 5) with Samples D38a and D38b (corresponding to Sample C36 from Table 5). As with D35a and D35b, D37a and D37b were fined with the conventional Cl—F-Ce-Sn package. D38a and D38b were fined with sodium sulfate and sodium nitrate. Again, the sulfate-fined glass samples (D38a, D38b) have fewer remaining bubbles than the samples fined with the conventional Cl—F-Ce-Sn package (D37a, D37b).

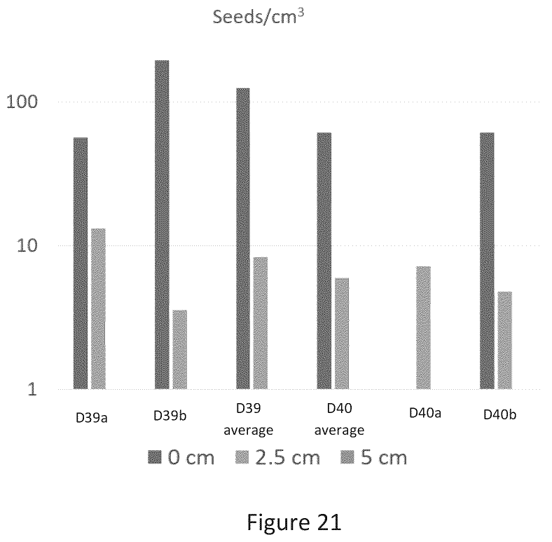

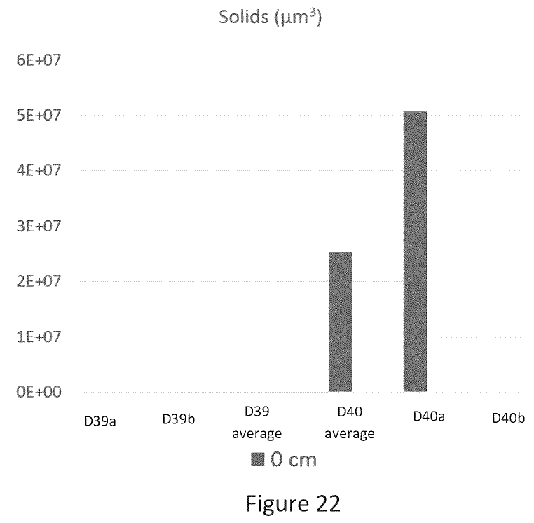

FIGS. 21 and 22 show bar graphs comparing Samples D39a and D39b (corresponding to Sample C35 from Table 5) with Samples D40a and D40b (corresponding to Sample C36 from Table 5). D39a and D39b were fined with the conventional Cl—F-Ce-Sn package. D40a and D40b were fined with sodium sulfate and sodium nitrate. Again, the sulfate-fined glass samples (D40a, D40b) have fewer remaining bubbles than the samples fined with the conventional Cl—F-Ce-Sn package (D39a, D39b).

Durability Experiments

Embodiments of this disclosure were also tested for durability. To test durability, an appropriate amount of raw material to obtain 1000 g of glass was set in 4 platinum crucibles and double melted in an electrical furnace heated by Globar® heating elements. The double melt was done to improve glass chemistry homogeneity. The glass compositions are indicated in Table 5. For the melting cycle, the crucibles were put into the furnace preheated at 1450° C., and held for 1 hour at 1450° C. Then, they were heated in 150 minutes from 1450° C. to 1550° C., and held at 1550° C. during 30 min, followed by a water draw. For the next melting cycle, the crucibles were put in the furnace preheated at 1450° C. and held for 1 hour at 1450° C. Then they were heated for 150 minutes from 1450° C. to 1550° C., and held at 1550° C. during a dwell time labeled D. For the glass having the composition of Sample C37 from Table 5, D Was 2 hours and 30 minutes, for the glass having the composition of Sample C35 from Table 5, D was 0 min. The crucibles were then extracted from the furnace and the molten glass was poured onto a preheated steel plate. It was rolled on the plate to a thickness of about 4 mm. Glass plates were annealed at 600° C. for 1 hour and subsequently cooled down slowly.

Durability tests were conducted according to standard ISO 695 for strong base resistance and CETC and according to standard DIN 12116 for strong acid resistance. For ISO 695, two glass samples of 25×25 mm, 1 mm-thick were prepared and polished on all faces. For ISO 695, two samples of 28 mm diameter, 3 mm-thick were prepared and polished on all faces. For DIN 12116, two glass samples 51 mm×76 mm, 1 mm-thick were prepared and polished on all faces 1 mm.

Results are reported in Tables 6 and 7 below, and show no significative difference between the two glasses: Sample C37 (fined with Cl, F, Ce, and Sn) and Sample C35 (sulfate fined).

TABLE 6
ISO 695 (strong base resistance)
mass Loss per Unit Area (mg/dm²) - Class

| Sample C37 | Sample 35 |
|---|---|
| 111 - A2 | 113 - A2 |
| 111 - A2 | 114 - A2 |
| 119.8 - A2 | 115.6 - A2 |
| 120.7 - A2 | 113.1 - A2 |

TABLE 7
DIN 12116 (strong acid resistance)
mean of the half mass loss per unit area (mg/dm²) - Class

| Sample 37 | Sample 35 |
|---|---|
| 1.03 - S2 | 0.99 - S2 |
| 0.91 - S2 | 0.98 - S2 |

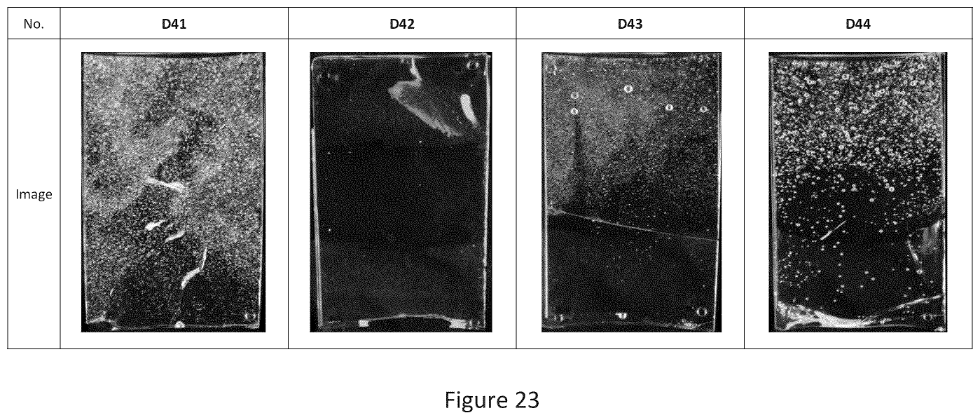

FIG. 23 shows a comparison table with four images of borosilicate glass compositions (Samples D41-D44; corresponding to compositions C22-C25 from Table 3). As comparative examples, Sample D41 contained no fining agent and Sample D42 was fined with NaCl. Because Cl is sometimes undesired as a fining agent, embodiments disclosure include Cl-free fining packages, such as those used for Samples D43 and D44. Sample D43 was fined with Na₂SO₄, and Sample D44 was fined with Na₂SO₄ and SnO₂.

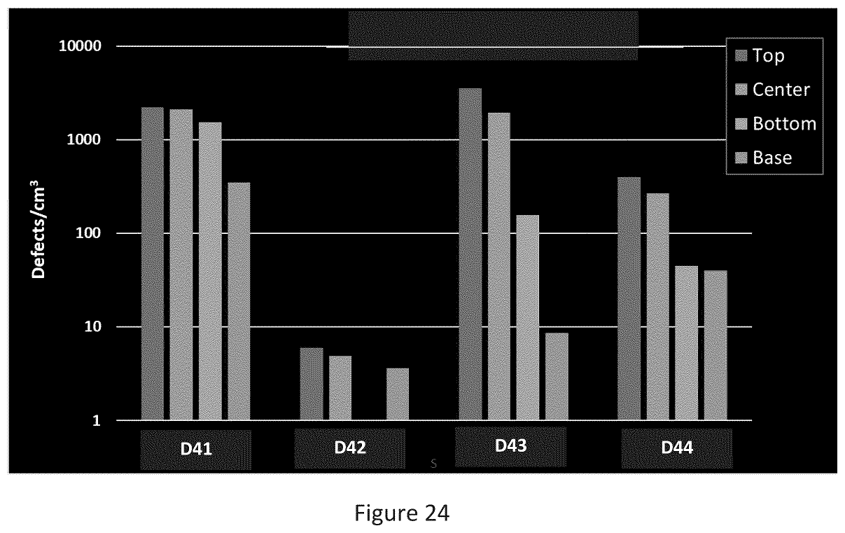

FIG. 24 shows a bar graph comparing the defects per cm³ at four locations (top, center, bottom, and base) in each of Samples D41-D44 from FIG. 23. The sulfate composition reduces the density of defects by 1 to 2 orders of magnitude in the bottom half of the crucible compared to no fining agent. The sulfate and tin composition reduces the density of defects by 1 to 2 orders of magnitude throughout the crucible compared to no fining agent.

“Include,” “includes,” or like terms means encompassing but not limited to, that is, inclusive and not exclusive. “About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the aspects of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, and like aspects, and ranges thereof, are for illustration only; they do not exclude other defined values or other values within defined ranges. The systems, kits, and/or methods of the disclosure can include any value or any combination of the values, specific values, more specific values, and preferred values described herein, including explicit or implicit intermediate values and ranges.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed aspects. Since modifications, combinations, sub-combinations and variations of the disclosed aspects incorporating the spirit and substance of the aspects may occur to persons skilled in the art, the disclosed aspects should be construed to include everything within the scope of the appended claims and their equivalents.

What is claimed is:

1. A fining package for a glass composition comprising:
a sulfate or a sulfide in an amount from about 0.001 to about 0.1 mol % of the glass composition.

2. The fining package of claim 1, wherein the fining package comprises the sulfate and is sulfide-free.

3. The fining package of claim 1, wherein the sulfate comprises at least one of an alkali sulfate and an alkaline earth sulfate.

4. The fining package of claim 1, wherein the fining package further comprises a multivalent compound in an amount from about 0.001 to about 1 mol % of the glass composition.

5. The fining package of claim 4, wherein the multivalent compound comprises Sn or Ce.

6. The fining package of claim 4, wherein the multivalent compound comprises CeO₂, SnO₂, or Fe₂O₃.

7. The fining package of claim 1, further comprising a nitrate in the amount of about 0.01% to about 0.1 mol % of the glass composition.

8. The fining package of claim 1, wherein the sulfate comprises a heavy alkaline earth sulfate.

9. The fining package of claim 8, further comprising a redox modifier.

10. The fining package of claim 1, wherein the fining package is free of a reducing agent for reducing sulfate to sulfide.

11. The fining package of claim 1, wherein the glass composition comprises a borosilicate glass composition.

12. The fining package of claim 1, wherein the glass composition comprises an aluminosilicate glass composition.

13. The fining package of claim 1, wherein the glass composition is used to form glass tubing or pharmaceutical packaging.

14. The fining package of claim 1, wherein the fining package is free of at least one of Cl, F, Sn, Ce, and As.

15. The fining package of claim 1, wherein the glass composition comprises:
SiO₂ in an amount of 70 to 76 wt % of the glass composition;
B₂O₃ in an amount of 9 to 13.5 wt % of the glass composition;
Al₂O₃ in an amount of 4 to 8 wt % of the glass composition;
TiO₂ in an amount of 0 to 0.1 wt % of the glass composition;
Fe₂O₃ in an amount of 0 to 0.1 wt % of the glass composition;
BaO in an amount of 0 to 0.1 wt % of the glass composition;
CaO in an amount of 0 to 3 wt % of the glass composition;
Na₂O in an amount of 5 to 8.5 wt % of the glass composition;
K₂O in an amount of 0.5 to 3 wt % of the glass composition;
MgO in an amount of 0 to 1 wt % of the glass composition;
Cl in an amount of 0 to 0.03 wt % of the glass composition;
F in an amount of 0 to 0.02 wt % of the glass composition;
CeO₂ in an amount of 0.08 to 0.5 wt % of the glass composition;
SnO₂ in an amount of 0.02 to 0.23 wt % of the glass composition; and
ZrO₂ in an amount of 0 to 0.08 wt % of the glass composition.

16. The fining package of claim 1, wherein the glass composition comprises:
SiO₂ in an amount of 75 to 85 wt % of the glass composition;
B₂O₃ in an amount of 9.5 to 14.5 wt % of the glass composition;
Al₂O₃ in an amount of 0.5 to 5 wt % of the glass composition;
TiO₂ in an amount of 0 to 0.1 wt % of the glass composition;
Fe₂O₃ in an amount of 0 to 0.1 wt % of the glass composition;
BaO in an amount of 0 to 0.1 wt % of the glass composition;
Na₂O in an amount of 2 to 8 wt % of the glass composition;
K₂ O in an amount of 0 to 3 wt % of the glass composition;
CaO and MgO in a total amount of 0 to 1.0 wt % of the glass composition;
Cl in an amount of 0 to 0.10 wt % of the glass composition; and
SnO₂ in an amount of 0 to 0.2 wt % of the glass composition

17. The fining package of claim 1, wherein the glass composition comprises:
SiO₂ in an amount of 74 to 80 wt % of the glass composition;
Al₂O₃ in an amount of 4 to 8 wt % of the glass composition;
CaO in an amount of 0 to 0.5 wt % of the glass composition;
Na₂O in an amount of 8 to 14 wt % of the glass composition;
MgO in an amount of 3 to 7 wt % of the glass composition; and
SnO₂ in an amount of 0 to 0.23 wt % of the glass composition.

18. A method of fining glass for forming pharmaceutical packaging comprising:
fining a glass composition by adding the fining package of claim 1 to the glass composition to remove gas bubbles; and
forming glass tubing from the fined glass composition.

19. The method of claim 18, further comprising forming a pharmaceutical packaging from the glass tubing.

20. The method of claim 18, wherein the fining is performed at a fining temperature of at least 1400° C.

21. The method of claim 19, further comprising:
melting a batch of materials for the glass composition, the batch of materials comprising sand with a D50 average particle size of greater than 200 microns, or greater than 300 microns.
